(19) United States
(12) Patent Application Publication
(10) Pub. No.: US 2016/0303807 A1
(43) Pub. Date: Oct. 20, 2016

(54) Multiple heatplate temperature control for 3D printers

(71) Applicant: Federico Diamante, Tampa, FL (US)

(72) Inventor: Federico Diamante, tampa, FL (US)

(21) Appl. No.: 15/132,176

(22) Filed: Apr. 18, 2016

Related U.S. Application Data
(60) Provisional application No. 62/178,701, filed on Apr. 16, 2015.

(51) Int. Cl. B29C 67/00; B33Y 50/02; B33Y 40/00

(52) U.S. Cl. CPC B29C 67/0088; B33Y 40/00; B33Y 50/02; B29C 67/0059; B33Y 10/00

(57) ABSTRACT

An improved 3D printer system that allows the use of multiple heatplates, a voltage and temperature sensing device that relays to the 3D printer which allows the usage of multiple heatplates, a system which allows 3D printers to increase the base printing area to an unlimited amount. In a preferred embodiment of the invention, a 3D printer will be able to print larger base sizes by having a larger heatplate system than in the prior art while also able to print more types of materials. A method where the system collects the temperature of a baseline heatplate, compares and controls the temperature of other heatplates connected in the system.

### BACKGROUND OF THE INVENTION

1. Field of the Invention

The present invention relates to a 3D Printer system which incorporates multiple heatplates into the printing surface of a 3D printer without the need to use a custom single and more costly heatplate. More specifically, the present invention relates principally to a temperature and voltage control system that is able to integrate multiple heatplates while maximizing the usage of already available heatplates. This system is a supplement to a 3D printer, which will allow a designer to build a 3D printer with a large print base size.

2. State of the Art

There are a variety of different circumstances under which a person may be required to design a 3D printer of large size, such as one that may require more than today's average printing size of 9 inches. As disclosed in U.S. Pat. No. 5,121,329, there is the need to have a heated base on to where a material is deposited. In some circumstances, such printing size may be needed in order to achieve large print models. In other circumstances, such large models will need to be printed in pieces. In other circumstances, they can be printed on large size 3D printers which contain a single larger heatplate or no heatplate. Heatplates are needed in 3D printers in order to maintain the integrity of the print as they are able to maintain the temperature of the deposited material.

The integrity of the print can be compromised if the incorrect temperature is applied to the deposited material, thus the reason to have a heatplate. The heatplate reduces the temperature gradient on the material from the moment it is deposited until further layers are applied. If a temperature change is too quick, it will cause such material to have a thermal shock thus altering its shape. In most instances, it bends upward away from the print surface. By having a thermally correct and even heatplate surface, the deposited material will maintain its shape and not warp.

If a large size 3D printer is built with a single large heatplate, it can be detrimental to the designer due to its nonstandard size. This will tend to greatly increase the cost of the printer because of the need to develop and manufacture a large custom heatplate. Another example is a large size 3D printer with no heatplate; such printer will reduce the types of materials it can print and the quality of the print, thus reducing the functionality of the machine.

Most 3D printers today use a single heatplate which reduces the functional printing area. Although a large printing area can be achieved, this is usually overcome with a printing base that contains a single and large heatplate. This method greatly increases the cost of the printer because of the need of a custom size heatplate. As disclosed in U.S. Pat. No. 9,168,697 a larger printing size may be achieved with a larger printing area, yet the use of a heatplate that is of the proportional size to the print area will drastically increase the price of the 3D printer. The advantage of the multiple heatplate temperature control system is that several small heatplates can be used to achieve a large system. In addition, this can be advantageous because of the ability to use commonly available heatplates that tend to be more inexpensive and standard in size.

By centralizing the temperature control and distributing the heating to smaller and more commonly used elements, a multiple number of heatplates can be used to significantly increase the size of the print base area to an unlimited size, providing the designer with the freedom to develop 3D printing systems that can print unlimited size objects. Thus, there is the need to have a system that is able to effectively increase the print base size of a 3D printer without having the limitation to have a large and costly single heatplate. There are several ways to centralize the temperature control system such as defined under U.S. Pat. No. 3,241,603 a temperature system is able to monitor and adjust temperature automatically. Such system can be applied to several different heating elements; in the case of a 3D printer it could control several heatplates, thus achieving the ability to have multiple heatplate temperature control.

### SUMMARY OF THE INVENTION

Thus, it is an object of the present invention to provide a multiple heatplate temperature control for a 3D printer system that is able to scale 3D printing to larger sizes. It is another object of the present invention to provide a heatplate system that can be scaled along with the size of the 3D printer, which will maintain the integrity and quality of the print. It is yet another object of the present invention to provide such system which will be able to use commonly manufactured heatplates in any combination to achieve a desired printing area size. It is still another object of the present invention to do this in a more easily available and economical option to that is currently on the market.

### BRIEF DESCRIPTION OF THE DRAWINGS

The above and other objects, features and advantages of the invention will become apparent from a consideration of the following detailed description presented in connection with the accompanying drawings in which:

FIG. 1 shows an aerial view of a 3D printer model and a multiple heatplates system on its base printing area;

FIG. 2 shows an image of the flow chart diagram of the algorithm of the process for the multiple heatplate temperature control for 3D printers;

FIG. 3 shows an image of the schematic of the multiple heatplate temperature control for a 3D printer system with an “n” number of heatplates;

FIG. 4 shows an image of how an individual heatplate interacts with the multiple heatplate temperature control system.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

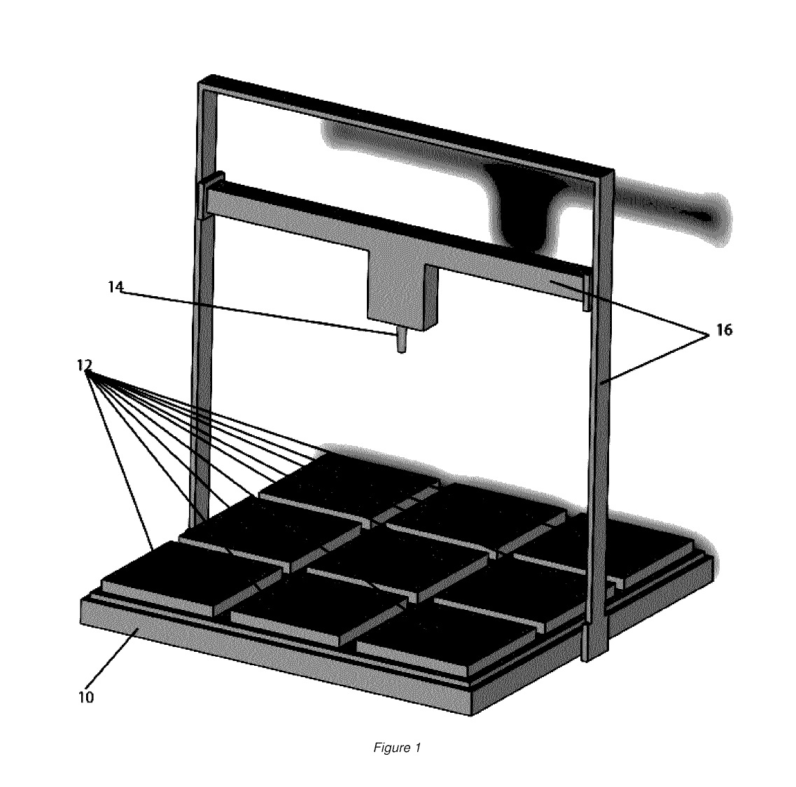

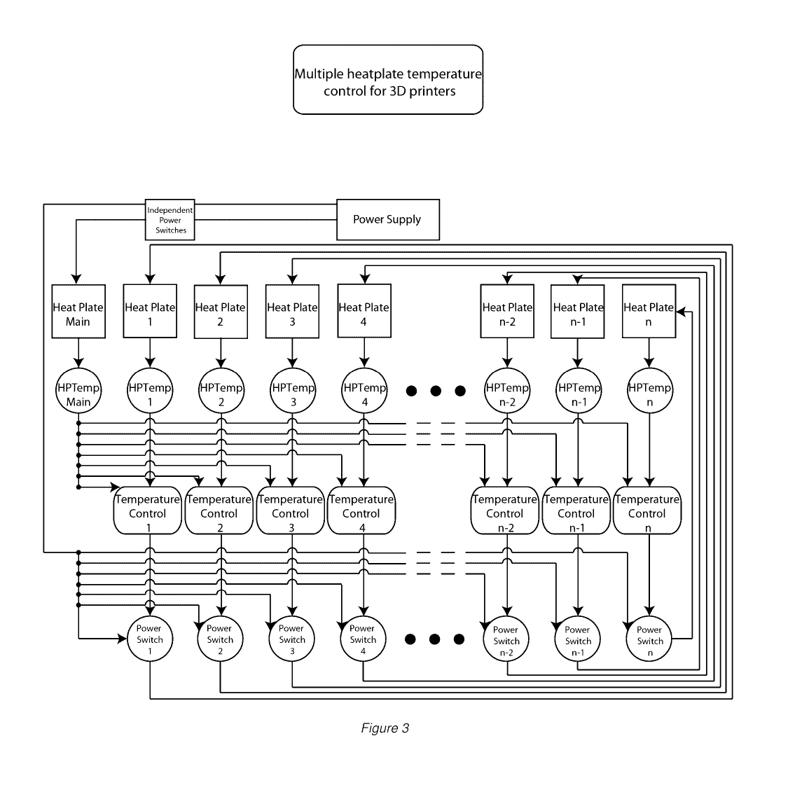

Referring to FIG. 1, there is shown an aerial view of a 3D printer that contains a lower base 10, an upper frame 16, a dispensing head 14 and multiple heatplates 12 in accordance with the teachings of the prior art U.S. Pat. No. 5,121,329. The multiple heatplate temperature control for 3D printers is embedded, is inserted to the prior art. When a 3D printer is in operation it will work in conjunction along with the multiple heatplate temperature control system in order to achieve a larger print base area. The multiple heatplate temperature control uses a common heatplate's temperature to power on and off the rest of the heatplates as is shown in FIG. 3.

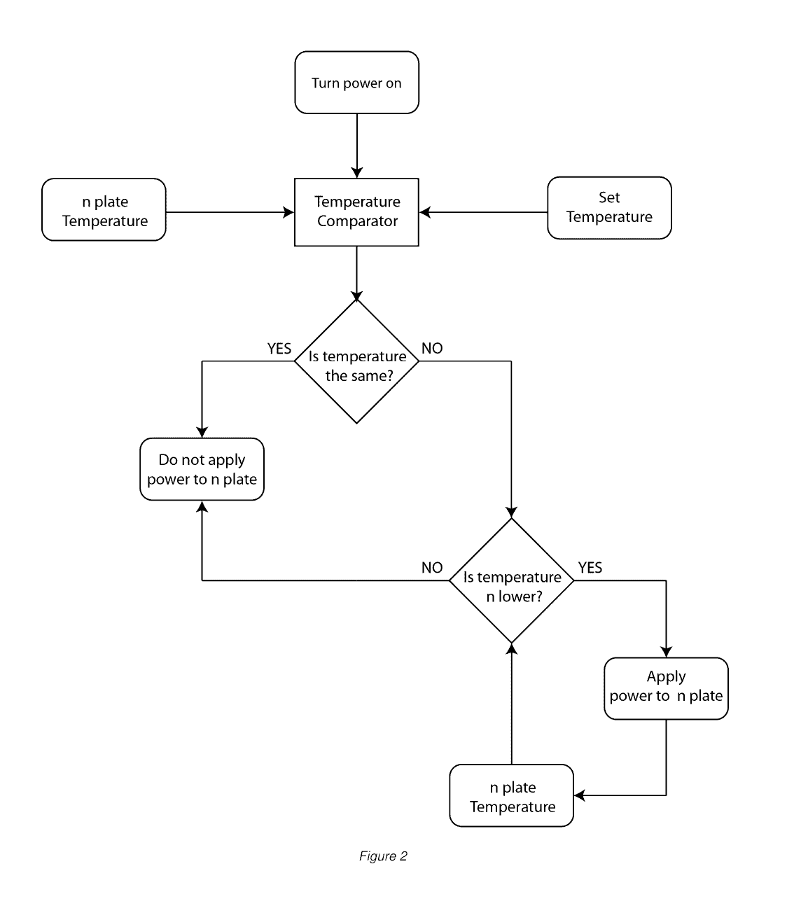

Turning now to FIG. 2, the multiple heatplate temperature control system showcases the logical flowchart of how it operates; once the temperature comparator is powered on, it receives input from an “n” heatplate and set temperature. Next the temperature comparator compares the temperature of the “n” heatplate to the set temperature, if the “is the temperature is the same?” check, the result is a YES, the system does not apply power to the “n” heatplate in order to maintain its temperature; if the “is the temperature is the same?” check, the result is a NO, then the system moves to “is the temperature lower?” check. If the “is the temperature lower?” check, a NO, the system does not apply power to the “n” heatplate; if the “is the temperature lower?” check, is a YES, the system does apply power to the “n” heatplate, which in turn is a closed loop input that the system uses to perform a continuous check on an “n” heatplate.

As shown in FIG. 3, the multiple heatplate temperature control system powers ON and OFF the Heatplate main, the system then uses its temperature to regulate Heatplate 1 through “n”; doing so by taking the HPTemp Main and using it as a baseline to compare it to the Heatplate 1 through “n” via the HPTemp 1 through “n”, which is used by the temperature control's 1 through “n”; the system then relates such temperature by applying power to Heatplate 1 through “n”. All of this operation is performed on a continuous monitored close loop circuit.

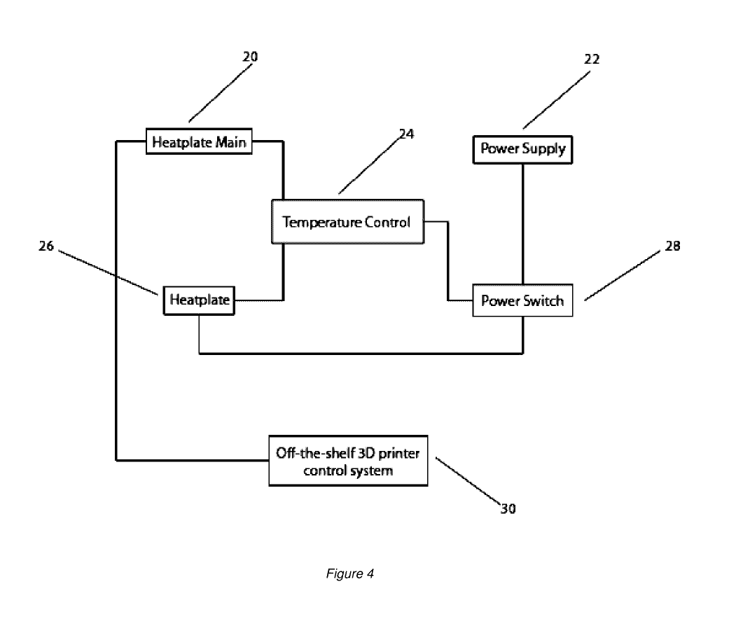

Referring to FIG. 4, we see how a multiple heatplate temperature control system is connected to a 3D printer. The system uses the 3D printer control system 30, to baseline the Heatplate Main 20 temperature, the Temperature Control 24 uses the temperature from Heatplate Main 20 to compare it to the “n” Heatplate 26. Once compared, it decides whether to enable the operation of the power supply 22, via the power switch.

I claim:

1. A multiple heatplate temperature control system device for 3D printers comprising:
a temperature control electrical circuit which measures a temperature of an “n” number of heatplates and the temperature of a temperature controlled heatplate of a 3D printer;
a temperature control electrical circuit which individually compares a temperature of an “n” number of heatplates to a temperature controlled heatplate of a 3D printer;
a system comprising of at least a set of one heatplate connected to the temperature control electrical circuit;
a system comprising of at least a set of one power switch to individually enable and disable the operation of the “n” number of heatplates connected to said temperature control electrical circuit;
a system comprising of at least a set of one power supply that powers on the “n” number of heatplates, which is connected and regulated by said power switch connected to said temperature control electrical circuit.

2. The device according to claim 1, wherein said circuit which measures temperature uses a device selected from the group consisting of thermistors and thermocouples and thermostat and thermometer and resistance thermometer and silicon bandgap temperature sensor to measure and translate said temperature to a voltage.

3. The circuit according to claim 2, wherein said voltage is compared using a device selected from the group consisting of transistor and operational amplifier and vacuum tube and a semiconductor device to measure said temperature that is translated to said voltage.

4. The device of claim 1, wherein said heatplate is selected from the group consisting of heatplate and heatbed and ribbon heater and radiant heater and space heater and convection heater and fan heater and light heater and heat pump and liquid heater and direct electric heat exchanger and electrode heater and infrared heater and microwave heater.

5. The device of claim 1, wherein said power switch is selected from the group consisting of transistors and relays and solid state switches.

6. A method for individually controlling a temperature of an “n” number of heatplates of a multiple heatplate temperature control system device for 3D printers via an individual “n” number of power switches with a system of power supplies by sensing a temperature of a temperature controlled heatplate of a 3D printer and comparing said temperature to an individual temperature of an individual “n” number of heatplates of said multiple heatplate temperature control system device for 3D printers, said method comprising the steps of:
sensing the temperature of said temperature controlled heatplate of a 3D printer;
sensing the individual temperature of said individual “n” number of heatplates of a multiple heatplate temperature control system device for 3D printers;
comparing the temperature of said temperature controlled heatplate of a 3D printer to the individual temperature of said individual “n” number of heatplates of a multiple heatplate temperature control system device for 3D printers;
determining whether to enable on or off said system of power supplies via said individual “n” number of power switches to power on or off the individual “n” number of heatplates of said multiple heatplate temperature control system device for 3D printers depending on whether the temperature of said individual “n” number of heatplates is lower or higher than the temperature of said temperature controlled heatplate of a 3D printer;
powering on or off said individual “n” number of heatplates of said multiple heatplate temperature control system device for 3D printers via said “n” number of power switches.

7. A method as defined in claim 6, wherein said sensing steps are taken in parallel.

8. A method as defined in claim 6, wherein both said sensing steps and said comparing step and said determining step and said powering step are repeated in sequence.

9. A method as defined in claim 6, wherein said powering method powers said individual “n” number of heatplates on, if the temperature of said individual “n” number of heatplates is lower than the temperature of said temperature controlled heatplate of a 3D printer.

10. A method as defined in claim 6, wherein said powering method powers said individual “n” number of heatplates off, if the temperature of said individual “n” number of heatplates is higher than the temperature of said temperature controlled heatplate of a 3D printer.
